(19) United States
(12) Patent Application Publication
(10) Pub. No.: US 2014/0150427 A1
(43) Pub. Date: Jun. 5, 2014

(54) GEOTHERMAL SYSTEM FOR REGULATING TEMPERATURE OF PAVEMENT AND SUPERSTRUCTURES

(71) Applicant: Emad FAROUZ, Potomac Falls, VA (US)

(72) Inventor: Emad FAROUZ, Potomac Falls, VA (US)

(21) Appl. No.: 14/097,026

(22) Filed: Dec. 4, 2013

Related U.S. Application Data
(60) Provisional application No. 61/733,231, filed on Dec. 4, 2012.

(51) Int. Cl. F03G 7/04; E01H 5/10

(52) U.S. Cl. CPC F03G 7/04; E01H 5/102
USPC 60/641.2; 126/271.1; 60/645

(57) ABSTRACT

A geothermal system is provided. The geothermal system may include a superstructure with at least one geothermal concrete layer, a geothermal source, a heat exchange system, a transfer medium, a distribution system having at least one pump, and a plurality of in-feed piping circuitously connected to a plurality of return piping, both embedded within the geothermal concrete layers. The heat exchange system may bring the transfer medium into contact with the geothermal source so as to convey its heat to the transfer medium. The at least one pump may pump the transfer medium throughout the distribution system, wherein the temperature of the superstructure may be regulated. A user may operate the distribution system to provide sufficient transfer medium to cure the geothermal concrete layer at a near ideal heat of hydration.

### BACKGROUND OF THE INVENTION

The present invention relates to geothermal transfer systems and, more particularly, to a multi-purpose geothermal system for regulating the temperature of structural elements.

Currently, the life span of transportation facilities is shortened by many factors including the use of melting agents to melt snow and ice, sub-optimal concrete curing during construction, and post-construction structural damage resulting from temperature-related forces. Additionally, transportation facilities' maintenance and serviceability also demand significant energy.

As can be seen, there is a need for one system that, when coupled to a transportation facility, pavement or superstructure, improves the curing of the concrete during construction, that lessens the impact of temperature-related damages to the concrete, that melts snow and ice from the concrete, and that provides power through the life of the superstructure or pavement.

### SUMMARY OF THE INVENTION

In one aspect of the present invention, a system for regulating the temperature of structural elements comprises: a heat exchange system comprising a geothermal loop configured to contact a geothermal source, wherein the geothermal loop contains a heat transfer thermal medium; a distribution system comprising: a superstructure; an in-feed piping embedded within the superstructure and interconnecting the geothermal loop to the superstructure, wherein the in-feed piping is configured to transmit the thermal medium from the geothermal loop to and through the superstructure; and a return piping embedded within the superstructure and connected to the in-feed piping, wherein the return piping is configured to transmit the thermal medium from the in-feed piping back to the geothermal loop; and at least one pump for pumping the thermal medium through the heat exchange system and through the distribution system.

In another aspect of the present invention, a method of regulating the temperature of structural elements comprises: placing a geothermal loop below the ground of the earth's surface thereby contacting the geothermal loop with a geothermal source, wherein the loop comprises an input and an output; placing a reinforcement structure on the earth's surface; arranging a plurality of piping comprising an in-feed piping and a return piping on the reinforcement structure; connecting the in-feed of the plurality of piping to the output and connecting the return of the plurality of piping to the input; creating a superstructure by pouring concrete over the piping and onto the reinforcement structure, thereby embedding the piping within the concrete; and pumping a thermal transfer medium from the geothermal loop into the in-feed through the superstructure, into the return piping and back into the geothermal loop.

These and other features, aspects and advantages of the present invention will become better understood with reference to the following drawings, description and claims.

### BRIEF DESCRIPTION OF THE DRAWINGS

FIG. 1 is a side view of an exemplary embodiment of the present invention;

FIG. 2 is a perspective view of an exemplary embodiment of the present invention;

FIG. 3 is a perspective view of an exemplary embodiment of the present invention;

FIG. 4 is a side view of an exemplary embodiment of a foundational support of the present invention;

FIG. 5 is a plan view of an exemplary embodiment of the present invention;

FIG. 6 is a sectional view of an exemplary embodiment of the geothermal concrete layer of the present invention; and

FIG. 7 is a side view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a geothermal system that may include a geothermal concrete layer, a geothermal source, a heat exchange system contacting the geothermal source, a transfer medium, a distribution system having at least one pump, and in-feed piping circuitously connected to a return piping. The heat exchange system, the in-feed piping and the return piping may be configured to transmit the thermal medium. The in-feed piping and the return piping may be embedded within the geothermal concrete layer. The in-feed piping and the return piping may be connected to the heat exchange system. The at least one pump may pump the transfer medium from the heat exchange system into and through both in-feed piping and the return piping within the geothermal concrete layer and then back into and through the heat exchange system. A user may operate the distribution system to control the at least one pump so as to provide sufficient transfer medium to control the temperature of the geothermal concrete layer as it cures.

In certain embodiments, after construction of the superstructure a user may operate the distribution system to control the at least one pump so as to provide sufficient transfer medium to control the temperature of the geothermal concrete layer so that ice and snow thereon melts.

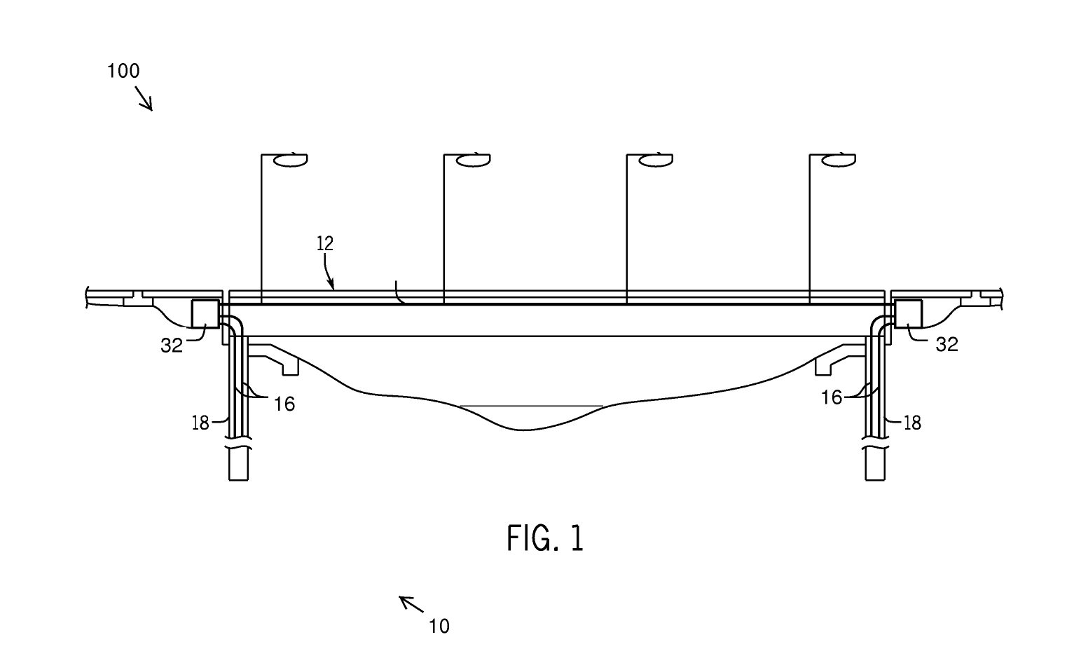

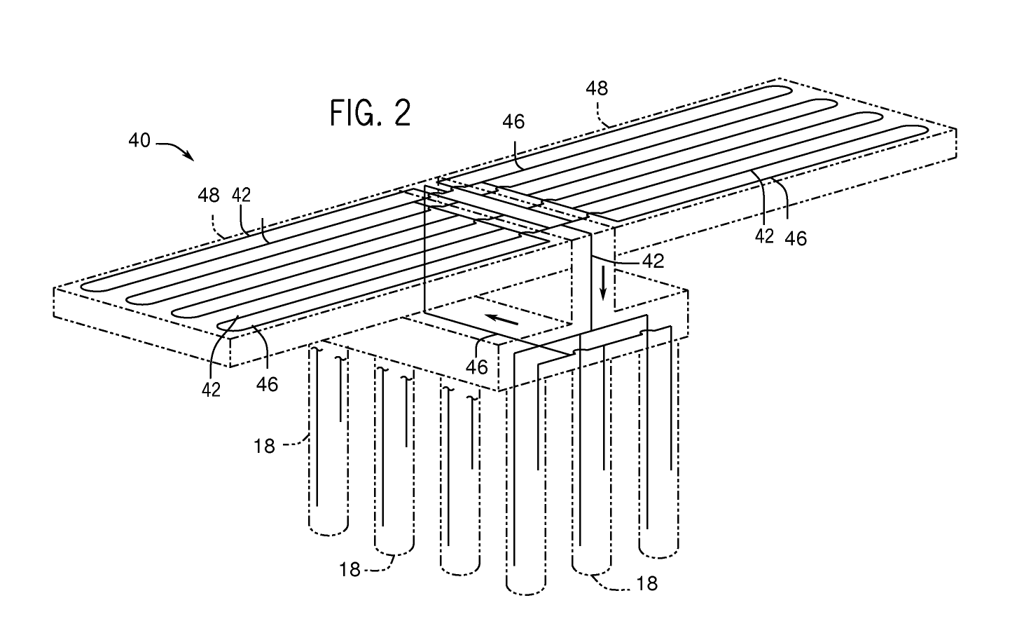

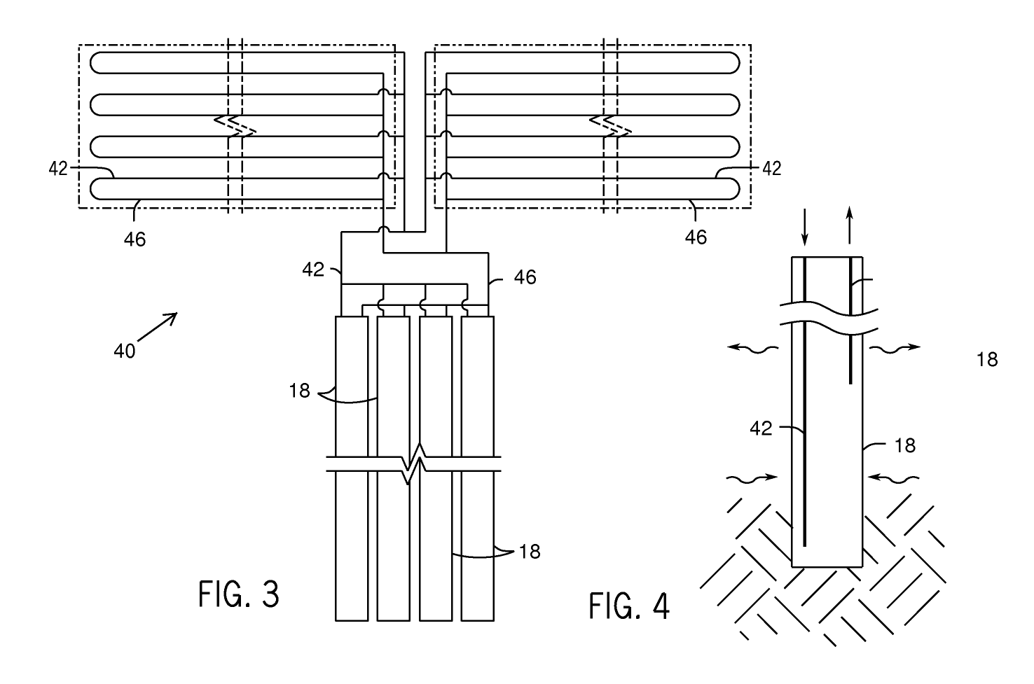

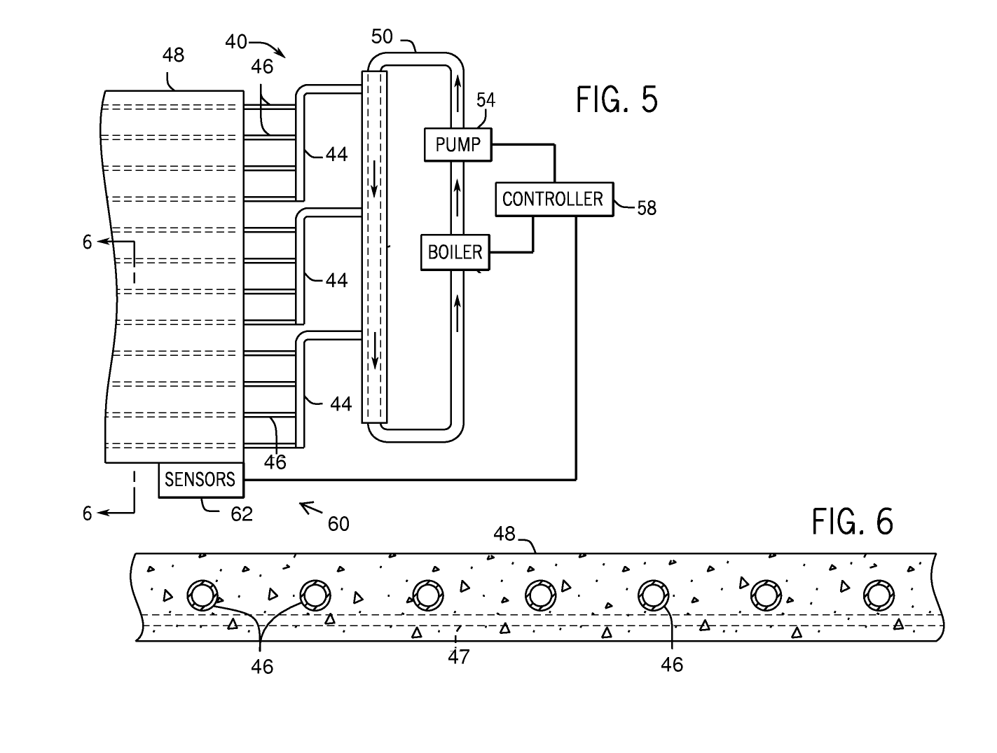

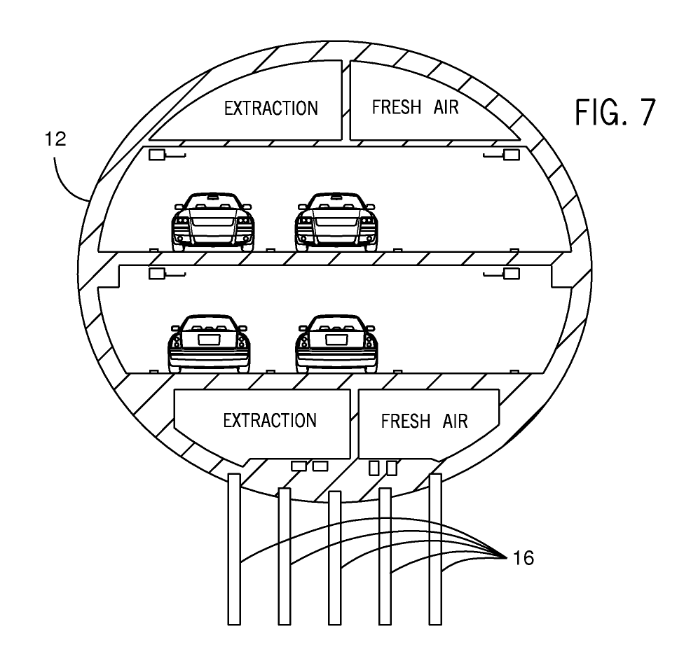

Referring to FIGS. 1 through 7, the present invention may include a geothermal system 100. The geothermal system 100 may include a superstructure 12, a geothermal source 10, a heat exchange system 20, a power system 32, a distribution system 40 and a monitoring system 60.

The heat exchange system 20 may include at least one drilled shaft containing at least one geothermal loop 16 containing transfer medium. The at least one drilled shaft may include deep foundational elements and the like. The at least one geothermal loop 16 may be a tube or the like for transmitting liquid or gas. The at least one geothermal loop 16 may include an input and an output. The transfer medium may include fluid, gas or both. The at least one drilled shaft or may be sufficiently deep into the ground so that the temperature of the surrounding earth is constantly at or around 55 to 65 degrees Fahrenheit. The geothermal loops 16 may be configured to convey the heat of geothermal source 10 to the transfer medium. The at least one geothermal loop 16 may be of sufficient size to produce a range of desired temperature. The at least one geothermal loops 16 may independently connect the geothermal source 10 to the superstructure 12. The superstructure may include pavement, a slab of pavement and the like. In certain embodiments, the at least one geothermal loops 16 may include cross sonic tubes, steel pipes, special geothermal plastic tubes, and the like.

In certain embodiments, the at least one drilled shaft or may include at least one foundational support 18 for the superstructure 12. The at least one foundational support 18 may contain the at least one geothermal loops 16 therein or thereon. In certain embodiments, the at least one geothermal loops 16 may be tied to the reinforcement of the at least one foundational support 18.

In certain embodiments, the geothermal system 100 may be retro-fitted to pre-existing superstructures 12 so as the heat exchange system 20 includes pre-existing culverts, pipes and the like when there is no access to drilled shafts and/or the at least one foundational support 18. In certain embodiments, the heat exchange system 20 may include at least one storage tank and at least one thermal transfer tank when there is no access to drilled shafts and/or the at least one foundational support 18. The at least one storage tank and at least one thermal transfer tank may be disposed underground, including, in certain embodiments, below the frost line.

The distribution system 40 may include in-feed piping 46, return piping 42, at least one pump 54, the superstructure 12, at least one controller 58, a series of manifolds 44, and a series of distribution loops 50.

The distribution system 40 may transmit the transfer medium from the heat exchange system 20 through the superstructure 12. The in-feed piping 46 and the return piping 46 may be of sufficient length and size for receiving sufficient transfer medium for regulating the temperature of the superstructure 12. The in-feed piping 46 may be connected to the output of the at least one geothermal loop 16. The return piping 42 may be connected to the input of the at least one geothermal loop 16. The in-feed piping 46 may be directly connected to the return piping 42. In certain embodiments, the in-feed piping 46 and return piping 42 may be circuitously connected through the series of manifolds 44 and the series of distribution loops 50 to the at least one pump 54. The at least one pump 54 may pump the transfer medium from the at least one geothermal loops 16 to and through the in-feed piping 46. The at least one pump 54 may continue pumping the same transfer medium to and through the return piping 42 back to the heat exchange system 20. The superstructure 12 may include at least one geothermal concrete layer 48. The at least one geothermal concrete layer 48 may include any composite material composed of coarse granular material embedded in a hard matrix of cementing material that fills the space among the aggregate particles and glues them together, such as concrete, asphalt, pavement and the like. In certain embodiments, the geothermal concrete layer 48 may include reinforcement 47. In certain embodiments, the reinforcement 47 may include deck slab, rebar, concrete forming material and the like. The in-feed piping 46 and the return piping 42 may be connected directly to and along the reinforcement 47 prior to the pouring of the at least one geothermal concrete layer 48 so that the in-feed piping 46 and the return piping 42 may be embedded within the at least one geothermal concrete layer 48.

The power system 32 may interconnect the heat exchange system 20 and the distribution system 40. The power system 32 may include a heat transfer pump powered by the temperature differential between the geothermal loops 16, the in-feed piping 46 and the return piping 42. The heat transfer pump may be a turbine, such as an organic rankin turbine or the like. The power system 32 may be configured to provide power to the superstructure 12 for maintenance and serviceability matters, such as lighting, ventilation, emergency power and the like.

In certain embodiments, the present invention includes a monitoring system 60. The monitoring system 60 may include at least one sensor 62. The monitoring system 60 may be connected to the distribution system 40. The sensor 62 may monitor the at least one geothermal concrete layer 48 to determine its ambient temperature. The at least one sensor 62 may automatically signal the at least one controller 58 to operate the distribution system 40, as needed, to compensate for the determined ambient temperature.

A method of using the present invention may include the following. The geothermal system 100 disclosed above may be provided. During construction of the superstructure 12, a user may operate the at least one controller 58 to pump transfer medium through in-feed piping 46 so that the geothermal concrete 48 may receive sufficient, controlled temperature conditions to optimize heat of hydration during curing so as to improve the strength, permeability, durability and hardness of the at least one geothermal concrete layer 48.

In certain embodiments, during operation of the superstructure 12, the user may operate the at least one controller 58 to pump transfer medium through in-feed piping 46 so that snow and ice melt off the at least one geothermal concrete 48. The user may extend the life of the superstructure 12 by obviating the chemical effects of snow and/or ice melting agents to and the loading of ice and/or snow removing vehicles on the geothermal concrete layer 48.

In certain embodiments, during operation of the superstructure 12, the user may operate the at least one controller 58 to pump transfer medium through in-feed piping 46 so that the at least one geothermal concrete layer 48 may be sufficiently cool to prevent micro-cracking and other damage related to temperature exposure.

In certain embodiments, the user may operate the power system 32 to provide sufficient power to the superstructure 12 to forego reliance on the power grid. Furthermore, the user may generate excess power that may be sold back to the power grid. As a result, the geothermal system 100 may save energy compared to traditionally powered superstructures 12.

It should be understood, of course, that the foregoing relates to exemplary embodiments of the invention and that modifications may be made without departing from the spirit and scope of the invention as set forth in the following claims.

What is claimed is:

1. A system for regulating the temperature of structural elements comprising:
a heat exchange system comprising a geothermal loop configured to contact a geothermal source, wherein the geothermal loop contains a heat transfer thermal medium;
a distribution system comprising:
a superstructure;
an in-feed piping embedded within the superstructure and interconnecting the geothermal loop to the superstructure, wherein the in-feed piping is configured to transmit the thermal medium from the geothermal loop to and through the superstructure;
a return piping embedded within the superstructure and connected to the in-feed piping , wherein the return piping is configured to transmit the thermal medium from the in-feed piping back to the geothermal loop; and
at least one pump for pumping the thermal medium through the heat exchange system and through the distribution system.

2. The system of claim 1, wherein the superstructure comprises a geothermal concrete layer covering a reinforcement layer, wherein the in-feed piping and the return piping are embedded within the geothermal concrete layer.

3. The system of claim 2, further comprising a power system interconnecting the heat exchange system to the distribution system so that a turbine receives a portion of the in-feed piping, the return piping and the geothermal loop.

4. The system of claim 3, wherein the power system comprises a turbine configured to convert the temperature differential between the received in-feed piping, the return piping and the geothermal loop into electrical energy.

5. The system of claim 1, wherein the geothermal loop is housed in a foundational support within a drilled shaft in the earth's surface.

6. A method of regulating the temperature of a superstructure comprising:
placing a geothermal loop below the ground of the earth's surface thereby contacting the geothermal loop with a geothermal source, wherein the loop comprises an input and an output;
placing a reinforcement structure on the earth's surface;
arranging a plurality of piping comprising an in-feed piping and a return piping on the reinforcement structure;
connecting the in-feed of the plurality of piping to the output and connecting the return of the plurality of piping to the input;
creating a superstructure by pouring concrete over the piping and onto the reinforcement structure, thereby embedding the piping within the concrete; and
pumping a thermal transfer medium from the geothermal loop into the in-feed through the superstructure, into the return piping and back into the geothermal loop.

7. The method of claim 6, further comprising the step of providing a turbine receiving a portion of the in-feed piping, the return piping and the geothermal loop.

8. The method of claim 7, wherein the turbine is configured to convert the temperature differential between the received in-feed piping, the return piping and the geothermal loop into electrical energy.
